(19) United States
(12) Patent Application Publication
(10) Pub. No.: US 2008/0164305 A1
(43) Pub. Date: Jul. 10, 2008

(54) Information transfer system, method, and apparatus

(76) Inventor: Kares Kettering Ball, Bloomfield Hills, MI (US)

Correspondence Address: Kares K. Ball, 44 Brady, Bloomfield Hills, MI, 48304, US

(21) Appl. No.: 12/006,856

(22) Filed: Jan. 7, 2008

Related U.S. Application Data
(60) Provisional application No. 60/878,866, filed on Jan. 5, 2007.

(51) Int. Cl. G06F 17/00

(52) U.S. Cl. 235/375

(57) ABSTRACT

The present invention is a data transfer system and method in which paper-based forms sum up patient encounter information using a combination of machine readable barcodes and OMR bubbles to transfer patient encounter information from paper forms into electronic medical billing information systems.

### CROSS-REFERENCE TO RELATED APPLICATIONS

This application is a conversion of and claims priority to prior U.S. Provisional Patent Applications, Ser. No. 60/878,866 entitled IMPROVED INFORMATION TRANSFER SYSTEM, METHOD, AND APPARATUS filed on Jan. 5, 2007, which is herein incorporated by reference in its entirety.

### BACKGROUND OF THE INVENTION

1. Field of the Invention

The present invention relates generally to the transfer of information necessary throughout the medical billing cycle used in hospitals, clinics, individual practitioner's offices, pharmacies, insurance companies, and third-party medical billing agencies. The present invention, also known as “Biller's Advantage” is suitable for use by hospitals, clinics, individual practitioners, pharmacies, insurance companies, and third-party medical billing agencies as an aid for the transfer of information from paper into digital systems that are the heart of modern medical billing information systems. More particularly, the present invention is a system and method in which paper-based forms sum up information using a combination of barcodes and OMR. More particularly, though not exclusively, the present invention is a system and method that employs a cost-effective combination of software and hardware to aid in the efficient, accurate, and secure information transfer via easy-to-use paper-based forms into medical billing information systems via barcode and OMR scanning.

2. Problems in the Art

Medical billing is the process of submitting and following up on claims to insurance companies in order to receive payment for services rendered by a healthcare provider. The same process is used for most insurance companies, whether they are private companies or government-owned.

The billing process is an interaction between the provider and the insurance company (payer). It begins with the office visit. After the provider sees the patient, depending on the service provided and the examination, the doctor creates or updates the patient's medical record. This record contains a summary of treatment and demographic information related to the patient. Upon the first visit, the provider will usually give the patient a diagnosis (or possibly several diagnoses); in order to better coordinate and streamline his/her care. The patient record contains personal information, nature of illness, diagnosis and suggested treatment as well. This whole process—the first visit—is called an ‘encounter’.

The treatment, diagnosis, and duration of service combine to determine the procedure code that will be used to bill the insurance. The doctor then either provides this information to a medical coder or other billing specialist. From this, a billing record, either paper (usually on a standardized form called an HCFA, named for the previous name for the Centers for Medicare and Medicaid Services) or electronic, is generated. This form includes the various diagnoses identified by numbers from the current ICD-10 manual.

This billing record or claim is then submitted either to a clearinghouse that acts as an intermediary for the information (this is typical for electronic billing) or directly to the insurance company. Some of the electronic transactions are sent via Electronic Data Interchange (EDI).

Choosing a clearinghouse is very cost effective for medical billing because they edit the claim based on the rules stated by the payer. If the claim does not meet necessary criteria, the claim is sent back to the user, so they can make corrections and quickly retransmit it. This saves time as well as later complications.

The insurance company (payer) processes the claim. The insurance side of the process begins with testing the validity of the claim for payment. The tests cover patient eligibility for payment, provider credentials, and medical necessity. Upon passing successfully the tests, the payer pays the claim. If a claim fails the tests, the payer rejects the claim and communicates the rejection message to the claim submission source.

Upon receiving the rejection message, the provider must decipher the message, reconcile it with the original claim, make required corrections, and resubmit the claim again. This exchange of claims and messages may repeat multiple times until the claim is paid in full.

The frequency of rejections, denials, and underpayments is high (often reaching 50%), mainly because of high complexity of claims and data entry errors.

In order to be clear on the payment of a medical billing claim, the physician must have complete knowledge of different insurance plans that insurance companies are offering, and the laws & regulations that preside over them. Large insurance companies can have up to 15 different plans contracted with one physician. That is why the amount is settled between the physician and the company before he provides his services and is paid according to the each contract that has its own fee schedule, billing rules and billing address.

Based on the amount negotiated by the doctor and the insurance company, the original charge is reduced. The amount that is paid by the insurance is known as an allowable. For example, although a psychiatrist may charge $80.00 for a medication management session, the insurance may only allow $50.00, so a $30 reduction would be assessed or otherwise called provider write off. After payment has been made a patient will typically receive an Explanation of Benefits (EOB) that outlines these transactions.

The insurance payment is further reduced if the patient has a copay, deductible, or a coinsurance. If the patient in the previous example had a $5.00 copay, the doctor would be paid $45 by the insurance. The doctor is then responsible for collecting the out-of-pocket expense from the patient. If the patient had a $500.00 deductible, the patient would have to pay the contracted rate of $50 ten times until the deductible was met, at which point the insurance would begin to cover a portion of the charge.

A coinsurance is a percentage of the allowed amount that the patient must pay. It is most often applied to surgical and/or diagnostic procedures. Using the above example, a coinsurance of 20% would have the patient owing $10 and the insurance company owing $40.

In Medicare the physician can either be ‘Participating’ in which he will receive 80% of the allowable Medicare fee and 20% will be sent to the patient or can be ‘Nonparticipating’ in which the physician will receive 80% of the fee, and may bill patients for 15% or more on the scheduled amount.

For example the regular fee for a particular service is $100, while Medicare's fee structure is $70. Therefore the physician will get $56, and the patient will pay $14. Similarly Medicaid has its own set of policies which are slightly more complex than Medicare.

In addition, the billing field has been challenged in recent years due to the introduction of the Health Insurance Portability and Accountability Act (HIPAA). HIPAA is a set of rules and regulations which hospitals, doctors, healthcare providers and health plans must follow in order to provide their services aptly and that there is no breach of confidence while maintaining patient records.

Since 2005 medical providers have been urged to electronically send their claims in compliance with HIPM to receive their payment.

Title I of this Act protects health insurance of workers and their families when they change or lose a job. While Title II calls for the electronic transmission of major financial and administrative dealings, including billing, electronic claims processing, as well as imbursement advice.

Medical billing service providers and insurance companies were not the only ones affected by HIPPA regulations—many patients found that their insurance companies and health care providers required additional waivers and paperwork related to HIPAA.

As a result of these changes, software companies and medical offices spent thousands of dollars on new technology and were forced to redesign business processes and software in order to become compliant with this new act.

There is clearly an unfilled need for a system, method, and apparatus which solves the problem of HIPPA compliant, cost effective, accurate, secure, and efficient transfer of medical billing information from the paper-based sources for an encounter into digital medical billing information systems. The present invention has as its primary objective fulfillment of these needs.

### Features of the Invention

A general feature of the present invention is the provision of a system, method, and apparatus for the transfer of medical information from a paper-based form into digital medical billing information systems which overcomes the problems found in the prior art.

A feature of the present invention is the provision of a paper-based medical billing form that includes data represented as a combination of barcodes and OMR bubbles.

A further feature of the present invention is a medical billing system interface that is cost-effective.

A further feature of the present invention is a medical billing system interface that is easy to install and use.

A further feature of the present invention is a medical billing system interface that is accurate.

A further feature of the present invention is a medical billing system interface that is efficient.

A further feature of the present invention is a medical billing system interface that is HIPPA compliant.

A further feature of the present invention is a medical billing system interface that captures information represented using barcodes and OMR bubble with a conventional hardware scanner.

A further feature of the present invention is a medical billing system interface that outputs one or more XML data files.

One or more of these and/or other features and advantages of the present invention will become apparent from the following specification and claims.

### BRIEF DESCRIPTION OF THE DRAWING

FIG. 1 is a flow chart of the present invention.

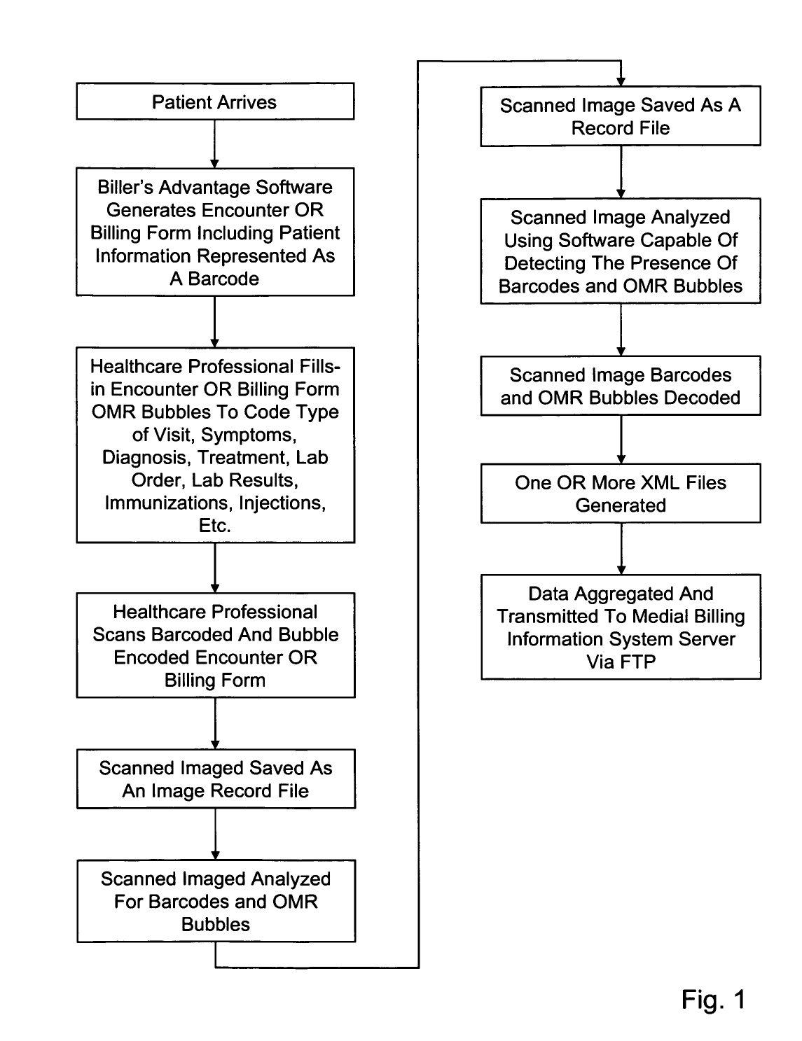

### SUMMARY OF THE INVENTION

The present invention relates generally to the transfer of information necessary throughout the medical billing cycle used in hospitals, clinics, individual practitioner's offices, pharmacies, insurance companies, and third-party medical billing agencies. The present invention, also known as “Biller's Advantage” (which is described in detail on the website http://www.billersadvantage.com/) is suitable for use by hospitals, clinics, individual practitioners, pharmacies, insurance companies, and third-party medical billing agencies as an aid for the transfer of information from paper into digital systems that are the heart of modern medical billing information systems.

The following comes from the “Biller's Advantage” website, and describes why the invention was developed, the basic flow of the invention, and its success in the marketplace:: [Beginning of Biller's Advantage website citation] A large physical therapy clinic performed an audit check of previously entered bills and estimated that they were loosing over $12,000 per month in unbilled services and treatments.

It did not take long to realize that the errors in missed billing charges were due to charge items being overlooked or mis-entered during the process of data entry. Billing charges are typically transferred through key-entry by a billing specialist who reads a billing sheet and enters the charges into an electronic billing system. The key was to find a way to increase the accuracy of data entry without disrupting the office work flow.

The solution was to “automate” the standard encounter form, or billing sheet. The information, diagnostics and procedures remained the same, but were organized to lay out choices in computer readable format. Instead of placing an X in a box next to a procedure, the doctor would simply fill in a “bubble” with a pen. A key requirement was that the billing sheet choices matched the type of charges and procedures used at a practice.

The result was an invention that is flexible to any kind of medical practice and can interface with virtually any billing system. Billing sheets that are encoded with customer information and the office's procedure codes are all printed on standard paper using a standard printer (laser printers are recommended).

The billing sheet is printed at the time of the patient visit or pre-printed ahead of time. Billing sheets are filled out by the provider, then scanned into Biller's advantage. After a quick check of the data, the transfer of the charge information to the billing system is performed. There is no keyed data entry, accuracy is increased, and the whole process saves time. Less time and more accurate translates to real revenue increases.

An additional module was adapted to Biller's advantage to add a logic check to make sure that the marked information on the billing sheet makes sense. For example, a child visit for fever would likely not include a root canal—an extremely unlikely event, but cases like this are easily flagged by the unique “sanity check” system—an available option to Biller's Advantage.

Biller's Advantage is now in use at medical offices in six states. Check our success stories for real life examples of how Biller's Advantage has helped offices like yours to realize increased productivity and enhanced revenue streams. [End of Biller's Advantage website citation]

Therefore, the present invention is a system and method in which paper-based forms sum up information using a combination of barcodes and OMR bubbles. The present invention employs barcodes that are known in the art as 1-Dimensional (1D) barcodes. A barcode is a machine-readable representation of information in a visual format on a piece of paper or other surface. 1-Dimensional barcodes store data using various combination of widths and spacings of printed parallel lines. Barcodes are read by optical scanners called barcode readers or detected using software to analyze a scanned image. Barcodes are widely used to implement Auto ID Data Capture (AIDC) systems that improve the speed and accuracy of computer data entry. 1D barcode symbologies can represent up to the entire ASCII character set in some instances.

The mapping between messages and barcodes is called a symbology. The specification of a symbology includes the encoding of the single digits/characters of the message as well as the start and stop markers into bars and space, the size of the quiet zone required to be before and after the barcode as well as the computation of a checksum.

Linear symbologies can be classified mainly by two properties: 1) Continuous vs. discrete: Characters in continuous symbologies usually abut, with one character ending with a space and the next beginning with a bar, or vice versa. Characters in discrete symbologies begin and end with bars; the intercharacter space is ignored, as long as it is not wide enough to look like the code ends, and 2) two-width vs. many-width: Bars and spaces in two-width symbologies are wide or narrow; how wide a wide bar is exactly has no significance as long as the symbology requirements for wide bars are adhered to (usually two to three times more wide than a narrow bar). Bars and spaces in many-width symbologies are all multiples of a basic width called the module; most such codes use four widths of 1, 2, 3 and 4 modules.

Some symbologies use interleaving. The first character is encoded using black bars of varying width. The second character is then encoded, by varying the width of the white spaces between these bars. Thus characters are encoded in pairs over the same section of the barcode. Interleaved 2 of 5 is an example of this.

The 1D barcodes used in the present invention can be either open source or proprietary. The present invention can use 1-Dimensional barcodes, such as, but not limited to, the following can be used with the present invention when an appropriate scanner and decoder are available: UPC-A, UPC-E, EAN-8 JAN-8, EAN-13 JAN-13, Code 39, Extended Code 39 (also known as code 3 of 9), Code 93, Extended code 93, Interleaved 2 of 5 (also known as code 25 Interleaved), Industrial 2 of 5 (also known as code 25 Industrial), Matrix 2 of 5 (also known as code 25 Matrix), Code 128, EAN 128, UCC 128, Codabar, Monarch, MSI Plessey, RSS14, RSS14 Stacked, RSS14 Truncated, RSS Limited, RSS Expanded, and 2D complement for RSS barcode. In the present invention, typically, a patient's demographic information will be displayed using 1D barcodes. Other information can be represented using 1D barcodes as needed.

In addition, the present invention can use un-tagged 2-Dimensional (2D) barcodes in a partitioned format similar to how data is stored and identified on a Radio Frequency Identification (RFID) tag. The drive to encode more information in combination with the space requirements of simple barcodes led to the development of matrix codes (a type of 2D barcode), which do not consist of bars but rather a grid of square cells. There are several terms now being used to describe this new class of keyless data entry symbologies. Two-dimensional code or 2-D code really is generic to this entire class.

The terms stacked symbology or multi-row code are more accurately applied to those symbologies made up of a series of one-dimensional barcodes. The data is coded in a series of bars and spaces of varying width.

The term Matrix code applies to 2-D codes that code the data based on the position of black spots within a matrix. Each black element is the same dimension and it is the position of the element that codes the data.

Ordinary barcodes are “vertically redundant”, meaning that the same information is repeated vertically. It is in fact a one-dimensional code. The heights of the bars can be truncated without any lose of information. However, the vertical redundancy allows a symbol with printing defects, such as spots or voids, to still be read. The higher the bar heights, the more probability that at least one path along the barcode will be readable.

A two-dimensional code stores information along the height as well as the length of the symbol. In fact, all human alphabets are two-dimensional codes. Since both dimensions contain information, at least some of the vertical redundancy is gone. Other techniques must be used to prevent misreads and to produce an acceptable read rate. Misread prevention is relatively easy. Most two-dimensional codes use check words to insure accurate reading. Acceptable read rate is a different problem, and no research has been done to date to assess first read rates. Two-dimensional code systems have become more feasible with the increased use of moving beam laser scanners, and Charge Coupled Device (CCD) scanners. The 2-D symbol can be read with hand held moving beam scanners by sweeping the horizontal beam down the symbol. However, this way of reading such a symbol brings us full circle back to the way 1D barcode was read—by sweeping a contact wand across the symbol. The speed of sweep, resolution of the scanner, and symbol/reader distance take on the same criticality as with contact readers and one-dimensional barcode.

There are well over 20 different 2-D symbologies available today. The following is a list of a few of the more popular.

Stacked symbologies evolved as 1D codes—Code 39 and Code 128—stacked in horizontal layers to create the multirow symbologies, Code 49 and Code 16K, respectively. PDF417 followed in 1990 with added features that increased data capacity, improved data density, and strengthened reading reliability by a scanner. These features enabled decoding from scan paths that span multiple adjacent rows while incorporating error detection and correcting techniques. PDF417 encodes the full ASCII character set at a maximum of about 2000 characters to four square inches. Uniform Symbol Specifications for Code 49, Code16K, and PDF417 are available from AIM. SuperCode, a stacked code that can break data into small packets and create various shaped symbols, is also available

Matrix symbologies offer higher data densities than stacked codes in most cases, as well as orientation-independent scanning. A matrix code is made up of a pattern of cells that can be square, hexagonal, or circular in shape. Data is encoded via the relative positions of these light and dark areas, and encoding schemes use error detection and correction techniques to improve reading reliability and enable reading of partially damaged symbols. Matrix codes are scaleable and well-suited both as small ID marks on products and as conveyor-scannable symbols on shipped packages.

The present invention can also use 2-D barcodes instead of 1-D barcodes described in the preferred embodiment. When using 2-D barcodes, the data is horizontally partitioned in the barcode as a means to store and identify the data, much as an RFID tag stores and identifies data according to a decoding template that is used to identify length of data fields, and how to extract the correct data from a particular data field. This method is not particularly efficient, but since a 2-D barcode can store between 2,000 and 7,000 characters the present invention is not hampered in its use of a partioned 2-D barcodes. The following is one example of how data may be partitioned in a 2-D barcode for use as an alternate embodiment of the present invention. This method avoids tagging the data within the barcode using a proprietary standard, or an open tagging standard, such as, but not limited to, XML.

TABLE 1
Decoding Template For A String Of Partitioned Data
Contained In A 2-D Barcode

| Characters | Data Field | Padding Character |
|---|---|---|
| 1-50 | Patient's First Name | % |
| | (Mary) | |
| 51-100 | Patient's Middle Name | % |
| | (Lee) | |
| 101-150 | Patient's Last Name | % |
| | (Smithson) | |
| 151-200 | Patient's ID Number | % |
| | 658999222 | |
| 201-250 | Patient's Birth Date | % |
| | Nov. 15, 1956 | |

The following is an example of a text string decoded from a partitioned 2D barcode.

%%%%%%%%%%%%%%%%%%%%%%%%%%%%%%%%%%%%%% %%%%%%%%%%% Mary %%%%%%%%%%%%%%%%%%%%%%%%%%%% %%%%%%%%%%%%%%%%%%%%%% Lee %%%%%%%%%%%%%%%%%% %%%%%%%%%%%%%%%%%%%%%%%%%%%%%%%%%%%658999222% %%%%%%%%%%%%%%%%%%%%%%%%%%%%%%%%%%%%%%%%%% Ser. No. 11/15/1956.

Optionally, the padding characters could be used to delineate variable length data fields.

It is obvious to one skilled in the art that a wide variety of partitioning schemes would be available for use with the present invention. The 2D barcode could also include a reference number that can be used to describe a particular partitioning scheme.

The present invention uses optical mark recognition technology, bubbles in particular, to identify various medical procedures and codes for a particular patient visit to a hospital, clinic, individual practitioner's office, pharmacy, etc., and for use by a third-party medical billing agency, or insurance company. OMR is the process of capturing data by contrasting reflectivity at predetermined positions on a page. By shining a beam of light onto the document the scanner is able to detect a marked area because it is more reflective than an unmarked surface. Some OMR devices use forms which are preprinted onto ‘Transoptic’ paper and measure the amount of light which passes through the paper, thus a mark on either side of the paper will reduce the amount of light passing through the paper.

It is generally distinguished from optical character recognition by the fact that a recognition engine is not required. The marks are constructed in such a way that there is little chance of not reading the marks correctly. This requires the image to have high contrast and an easily-recognizable or irrelevant shape.

One of the most familiar applications of optical mark recognition is the use of #2 (HB in Europe) pencil bubble optical answer sheets in multiple choice question examinations. Students mark their answers, or other information, by darkening circles marked on a pre-printed sheet. Afterwards the sheet is automatically graded by a scanning machine. The present invention uses this familiar form of OMR to code the non-demographic portion of the medical billing form.

In the past and presently, some OMR systems require special paper, special ink and a special input reader. This restricted the types of questions that can be asked and did not allow for much variability when the form was being inputted. However, recently much progress in OMR allows users to create and print their own forms and use a scanner (preferably with a document feeder) to read the information that has been OMR coded on a form. OMR systems approach one hundred percent accuracy and take very little time on average to recognize the OMR marks, such as bubbles that take the form of a square, circle, ellipse, or hexagon for the mark zone. The software can be set to recognize filled in bubbles, X's or check marks.

The present invention is a cost-effective combination of software and hardware to aid in the efficient, accurate, and secure information transfer via easy-to-use paper-based forms that use a combination of barcodes and OMR bubbles to represent information in a machine readable format, which one scanned is converted to an XML file for input into a medical billing information system.

XML provides a text-based means to describe and apply a tree-based structure to information. At its base level, all information manifests as text, interspersed with markup that indicates the information's separation into a hierarchy of character data, container-like elements, and attributes of those elements. In this respect, it is similar to the LISP programming language's S-expressions, which describe tree structures wherein each node may have its own property list.

The fundamental unit in XML is the character, as defined by the Universal Character Set. Characters are combined to form an XML document. The document consists of one or more entities, each of which is typically some portion of the document's characters, stored in a text file.

XML files may be served with a variety of Media types. RFC3023 defines the types “application/xml” and “text/xml”, which say only that the data is in XML, and nothing about its semantics. The use of “text/xml” has been criticized as a potential source of encoding problems but is now in the process of being deprecated. RFC3023 also recommends that XML-based languages be given media types beginning in “application/” and ending in “+xml”; for example “application/atom+xml” for Atom. This page discusses further XML and MIME.

The ubiquity of text file authoring software (basic text editors such as Notepad and TextEdit as well as word processors) facilitates rapid XML document authoring and maintenance. Prior to the advent of XML, there were very few data description languages that were general-purpose, Internet protocol-friendly, and very easy to learn and author. In fact, most data interchange formats were proprietary, special-purpose; “binary” formats (based foremost on bit sequences rather than characters) that could not be easily shared by different software applications or across different computing platforms, much less authored and maintained in common text editors. By leaving the names, allowable hierarchy, and meanings of the elements and attributes open and definable by a customizable schema, XML provides a syntactic foundation for the creation of custom, XML-based markup languages. The general syntax of such languages is rigid—documents must adhere to the general rules of XML, assuring that all XML-aware software can at least read (parse) and understand the relative arrangement of information within them. The schema merely supplements the syntax rules with a set of constraints. Schemas typically restrict element and attribute names and their allowable containment hierarchies, such as only allowing an element named ‘birthday’ to contain 1 element named ‘month’ and 1 element named ‘day’, each of which has to contain only character data. The constraints in a schema may also include data type assignments that affect how information is processed; for example, the ‘month’ element's character data may be defined as being a month according to a particular schema language's conventions, perhaps meaning that it must not only be formatted a certain way, but also must not be processed as if it were some other type of data.

In this way, XML contrasts with HTML, which has an inflexible, single-purpose vocabulary of elements and attributes that, in general, cannot be repurposed. With XML, it is much easier to write software that accesses the document's information, since the data structures are expressed in a formal, relatively simple way.

XML makes no prohibitions on how it is used. Although XML is fundamentally text-based, software quickly emerged to abstract it into other, richer formats, largely through the use of data type-oriented schemas and object-oriented programming paradigms (in which the document is manipulated as an object).

The conversion of machine readable barcoded and OMR bubble encoded data into the widely accepted and supported XML format allows for the easy transmission, manipulation, parsing, and input of paper-based data into medical billing information system databases, which most typically can handle XML SOA transactions.

### DETAILED DESCRIPTION OF THE INVENTION

The present invention relates generally to the transfer of information necessary throughout the medical billing cycle used in hospitals, clinics, individual practitioner's offices, pharmacies, insurance companies, and third-party medical billing agencies. The present invention, also known as “Biller's Advantage” is suitable for use by hospitals, clinics, individual practitioners, pharmacies, insurance companies, and third-party medical billing agencies as an aid for the transfer of information from paper into digital systems that are the heart of modern medical billing information systems.

The following steps represent the preferred embodiment of the present invention for the coding, scanning, decoding, conversion to XML, and input of data into digital medical billing information systems using the paper-based interface encounter document that includes both machine readable barcodes and OMR bubble encoded data:

1. An encounter form is printed using the present invention's software, which encodes patient and provider information on the printed form using 1D or 2D barcodes (which contains data encoded using a standard or proprietary horizontally partitioned data scheme). The encounter form includes data such as, but not limited to, the data of service, form type, patient ID, Provider (Doctor) code, office location and patient name are all stored in barcode format. Selection(s) of diagnostic codes and treatment codes are selected according to what the doctor prescribes. This form also shows the co-pay status for the patient in an additional barcode. If a code is not listed on the form, it can be added in the “custom code matrix”

2. A healthcare professional uses a pen or pencil to mark bubbles on the form to encode the various, specific, information related to a particular encounter. This information could be related to the type of office visit, symptoms, procedures, immunizations, injections, lab tests and results, etc.

3. When the patient visit is completed, the present invention's form is manually or machine fed into a scanner. This scanner creates an image that is analyzed by scanner software that reads both the barcoded and OMR bubble encoded information

4. The scanner software outputs one or more XML files containing the scanned data

5. The present invention's software program processes the scanned data by reading the XML files

6. A record of the scanned data is retained

7. A transaction file that is read by the billing program is produced

8. A sanity check is included to produce a report of unlikely charge situations. This is to flag the medical office personnel that there is something unusual that must be checked before information is input into a medical billing information system. An example would be breast augmentation for a male, or testicular cancer for a female

9. A syntax checker produces quick visual acknowledgement of “Stop” or “Go” via the use of a red or green area on the software window to indicate “OK to process” or “Errors encountered”, as examples, but not limited as such.

10. Data is transferred to a central server using File Transfer Protocol (FTP)

It should be understood that the various aspects of the present invention described herein can be combined in various ways, as would be apparent to one skilled in the art having the benefit of this disclosure. It should also be appreciated that various modifications, adaptations, and alternatives may be made. It is of course not possible to describe every conceivable combination of components for purposes of describing the present invention. All such possible modifications are to be included within the spirit and scope of the present invention which is to be limited only by the following claims.

What is claimed is:

1. A method of data interchange, the method comprising: creating an electronic document that encodes at least one human readable data element also a machine readable barcode, and at least one human readable data element in conjunction with a corresponding OMR bubble for manual encoding; printing the document; manually encoding with a marking instrument at least one OMR bubble; scanning the completed paper form to create an image; decoding the image to extract barcoded and OMR bubble encoded data: outputting at least one XML filed that contains the data captured from the image; producing a human readable file for a quality control check; transmitting the data to another computer system.

2. The method of claim 1 wherein the barcode is a 1D barcode.

3. The method of claim 1 wherein the barcode is a horizontally partitioned 2D barcode.

4. The method of claim 3 wherein the partition length is static.

5. The method of claim 3 wherein the partition length is variable.
